(19) United States
(12) Patent Application Publication
(10) Pub. No.: US 2020/0129883 A1
(43) Pub. Date: Apr. 30, 2020

(54) PACKED INCOMPRESSIBLE CHROMATOGRAPHY RESINS AND METHODS OF MAKING THE SAME

(71) Applicant: Repligen Corporation, Waltham, MA (US)

(72) Inventors: James Ronald Peyser, Billerica, MA (US); Alan Kit Ho Chan, Quincy, MA (US)

(73) Assignee: Repligen Corporation, Waltham, MA (US)

(21) Appl. No.: 16/670,145

(22) Filed: Oct. 31, 2019

Related U.S. Application Data
(60) Provisional application No. 62/753,604, filed on Oct. 31, 2018.

(51) Int. Cl. B01D 15/22; B01D 15/20; B01J 20/285

(52) U.S. Cl. CPC B01D 15/22; B01J 20/285; B01D 15/206

(57) ABSTRACT

This disclosure provides chromatography columns that are packed with incompressible media such as ceramic hydroxyapatite particles, which exhibit high separation performance that is robust to transportation and multiple uses. The columns can be made by applying axial compression using rigid bodies, such as porous frits and/or flow regulators.

This application claims the benefit of priority to, U.S. Patent Application No. 62/753,604, filed Oct. 31, 2018, entitled “Packed Imcompressible Chromatography Resins and Methods of Making the Same,” which application is incorporated herein by reference in its entirety.

### FIELD OF THE DISCLOSURE

This disclosure relates to packed chromatography columns comprising incompressible resins, and methods of making the same.

### BACKGROUND

Column chromatography is a separation and/or purification technique in which a stationary “bed” of a packed chromatography medium (also called a resin) is contained within a rigid tube or column. The packing medium can be in the form of particles of a solid or gel (“stationary phase”) or a solid support material coated with a liquid stationary phase. Either way, the packing medium typically fills the inside volume of the column tube.

In general, column separations involve passage of a liquid sample (“mobile phase”) through the column and over a packed “bed” of chromatography medium. Some compounds in the sample will associate with the stationary phase and may be slowed relative to the mobile phase; compounds that associate more strongly with the stationary phase move more slowly through the column than those that associate less strongly, and this differential results in the compounds being separated from one another as they pass through and exit the column.

One important group of resins utilize ceramic hydroxyapatite particles (CHP) in the stationary phase. CHP particles are, generally, irregularly shaped and incompressible, and may fracture or shear under strong compression, vibration or mixing. Because of the sensitivity of CHP resins, it may be difficult to obtain stably packed beds without deterioration of CHP particles. Shipping and long-term storage of beds pre-made columns packed according to current industry protocols may cause settling or particle consolidation during transportation and storage. CHP columns packed-in-place are also susceptible to settling over repeated storage and use cycles, resulting in the formation of a gap between the upper flow regulator of the column and the upper surface of the bed. If this gap becomes sufficiently large, it can create a mixing chamber, resulting in poor chromatographic resolution. For many applications, a stable pre-packed CHP chromatography column with high structural integrity of CHP particles would be ideal, but such a column is not currently available.

### SUMMARY

This disclosure provides pre-packed CHP chromatography columns, and methods of making the same. The stability of the packed beds is increased, resulting in high performance that is maintained following transportation and/or storage, and over multiple uses of the column.

In one aspect, the disclosure relates to a chromatography column which has a tubular member having first and second ends, a first flow distributor secured to a first end of the tubular member, a second flow distributor secured to a second end of the tubular member, and a packed chromatography medium. The packed chromatography medium may comprise an incompressible component and may be disposed in the tubular member between the first and second flow distributors, and the packed chromatography medium may be formed by compression between the first and second flow distributors. The separation performance of the column may be characterized by a height-equivalent theoretical plate (HETP) value and an asymmetry value. The HETP value may not change by more than 10%, 20%, or 30% and/or the asymmetry value may not change by more than 10%, 20%, or 30% following a vibration exposure selected from (I) fixed displacement vibration of 25 mm total fixed displacement or (II) random displacement vibration of an overall Gᵣₘₛ level of 1.15.

In another aspect, wherein (a) the HETP value may not change by more than 10% and/or (b) the asymmetry value may not change by more than 10% following a shock exposure selected from (I) a drop of 150 mm, (II) an incline impact causing at least a 1.7 m/s velocity change, or (III) a horizontal impact causing at least a 1.7 m/s velocity change. The HETP value may not change by more than 10% and/or the asymmetry value may not change by more than 10% following a sequence of vibration-shock-vibration exposures, wherein the shock exposure is selected from (I) a drop of 150 mm, (II) an incline impact causing at least a 1.7 m/s velocity change, or (III) a horizontal impact causing at least a 1.7 m/s velocity change and wherein the vibration exposure is selected from (IV) fixed displacement vibration of 25 mm total fixed displacement or (V) random displacement vibration of an overall Gᵣₘₛ level of 1.15. The HETP and asymmetry values may not change by more than 5%, 10%, 15%, 20%, 25%, or 30%. The incompressible component may comprise a 40 μm ceramic hydroxyapatite. The packed chromatography medium may be compressed by at least 2%. In yet another aspect, the packed chromatography medium may be compressed by no more than 20%.

In another embodiment, at least one of the first and second flow distributors of the packed chromatography column comprises a porous polyethylene, polypropylene or polytetrafluoroethylene frit.

In one aspect, the disclosure relates to a chromatography column (e.g., a shelf stable, and/or transport stable chromatography column) comprising a tubular member having first and second ends, a first flow distributor secured to a first end of the tubular member, a second flow distributor secured to a second end of the tubular member, and a packed chromatography medium comprising an incompressible component, the packed chromatography medium being disposed in the tubular member between the first and second flow distributors. The packed chromatography medium may be formed by compression between the first and second flow distributors.

In various embodiments, the packed chromatography medium may be compressed by at least 2%. The packed chromatography medium may be compressed by no more than 20%.

The disclosure further relates to a chromatography column wherein the tubular member is oriented vertically during operation, and wherein a height of the packed chromatography medium within the tubular member remains substantially constant over at least 2, 3, 4, 5, 6, 7, 8, 9 or 10 chromatographic use cycles.

Chromatography columns used in various embodiments include those wherein a separation performance of the column is characterized by a height-equivalent theoretical plate (HETP) value and an asymmetry value, and wherein (a) the HETP value does not decrease by more than 2%, 3%, 4%, 5%, 10%, 20%, 30%, 40% or 50% over at least 2, 3, 4, 5, 6, 7, 8, 9 or 10 chromatographic use cycles, and/or (b) the asymmetry value does not increase or decrease by more than 5%, 10%, 20%, 30%, 40% or 50% over at least 2, 3, 4, 5, 6, 7, 8, 9 or 10 chromatographic use cycles.

The disclosure further relates to a chromatography column wherein the tubular member is oriented vertically during operation, and wherein a height of the packed chromatography medium within the tubular member remains substantially constant before and after shipping or storage.

Chromatography columns used in various embodiments include those wherein a separation performance of the column is characterized by a height-equivalent theoretical plate (HETP) value or an asymmetry value, and wherein the HETP value and/or the asymmetry value remains substantially constant before and after shipping or storage. Methods for calculating HETP values are known in the art.

The disclosure also relates to a chromatography column wherein a height of the packed chromatography medium within the tubular member remains substantially constant before and after shipping or storage.

In yet another aspect, the disclosure relates to a method of making a chromatography column, comprising compressing, between a first and a second flow distributor, a settled chromatography medium by at least 2.5%, thereby making a packed chromatography medium.

Continuing with this aspect of the disclosure, in some embodiments the packed chromatography medium is compressed by no more than 20%.

Further, in some embodiments at least one of the first and second flow distributors comprises a porous polyethylene, polypropylene or polytetrafluoroethylene frit.

The methods for calculating asymmetric values are known in the art. The methods for simulating storage and dropping conditions are known in the art, for example the International Safe Transit Association 2B testing.

In various embodiments, the HETP value and/or asymmetry value may not change by more than 10% following a vibration exposure selected from (I) fixed displacement vibration of 25 mm total fixed displacement or (II) random displacement vibration of an overall Gᵣₘₛ level of 1.15. The HETP value may not change by more than 10% and/or the asymmetry value may not change by more than 10% following a shock exposure selected from (I) a drop of 150 mm, (II) an incline impact causing a 1.7 m/s velocity change, or (III) a horizontal impact causing a 1.7 m/s velocity change. The HETP value may not change by more than 10% and/or the asymmetry value may not change by more than 10%, 15%, 20%, 25%, or 30%. following a sequence of vibration-shock-vibration exposures, wherein the shock exposure is selected from (I) a drop of 150 mm, (II) an incline impact causing at least a 1.7 m/s velocity change, or (III) a horizontal impact causing at least a 1.7 m/s velocity change and wherein the vibration exposure is selected from (IV) fixed displacement vibration of 25 mm total fixed displacement or (V) random displacement vibration of an overall Gᵣₘₛ level of 1.15.

A separation performance of the column may be characterized by a height-equivalent theoretical plate (HETP) value or an asymmetry value, and wherein the HETP value and/or the asymmetry value remains substantially constant before and after shipping or storage.

In an aspect, the present disclosure may describe a method of making a chromatography column. This method may comprise compressing a settled incompressibility chromatography medium by at least 2.5% between a first and second flow distributor, thereby making a packed chromatography medium.

In various aspects, the packed chromatography medium may be compressed by no more than 20%. At least one of the first and second flow distributors may comprise a porous polyethylene, polypropylene or polytetrafluoroethylene frit. The incompressible chromatography medium may be a ceramic hydroxyappetite resin. The incompressible chromatography medium may be poured into the column to a bed height of 18-25 cm. A first frit may be inserted into the bottom of the column, a ceramic hydroxyapatite resin slurry may be poured over the first frit to achieve a height of 15-20 cm, and a flow distributor and second frit may be inserted into the column. The resin may be flow-packed at 200 cm/hour, the flow distributor may be lowered to within 1 mm of the resin, and flow-packed at 200 cm/hour.

### BRIEF DESCRIPTION OF THE DRAWINGS

FIG. 1 shows a schematic diagram of an exemplary chromatography column as used in the embodiments described herein

FIG. 2 is a schematic cross-section of the column of FIG. 1.

FIG. 3 shows an elution profile for a control-packed column pre-consolidation.

FIG. 4 shows an elution profile for the control-packed column following bed consolidation.

FIG. 5 shows an elution profile for a column prior to axial compression.

FIG. 6 shows an elution profile for the same column tested in FIG. 5, following axial compression.

FIG. 7 shows an elution profile for the column of FIG. 6 after drying of the bed.

FIG. 8 shows an elution profile for the column of FIG. 7 run horizontally.

FIG. 9 shows an elution profile for a conditioning run for the column of FIG. 7 returned to the vertical position.

FIG. 10 shows the pressure vs. flow profile pre and post ISTA2B testing for 14 cm compression packing.

FIG. 11 shows the pressure vs. flow profile pre and post ISTA2B testing for scale-up compression packing on a 45.7 cm I.D. column.

### DETAILED DESCRIPTION

### Definitions

As used herein, the term “bed height” refers to the linear height of the bed of packed chromatography media particles contained within a completed chromatography column.

As used herein, a “packed bed” refers to the final state of chromatography media particles within a chromatography column. This final state is achieved in a variety of ways. For example, one method is to combine fluid flow followed by axial compression of the bed between the flow distributors, as described herein. Other methods known in the art include gravity settling of particles, vibration settling, and/or mechanical axial compression alone.

As used herein, a “flow distributor” is a component, e.g., a cylindrical component, which is secured at or near each end of a chromatography column. The flow distributors can be multi-part assemblies that serve multiple purposes. One function is to convey liquid into/out of the column by means of a port that can mate with different pipes/tubing that feed liquids into or out of the column. Another function is to direct inflow of liquid from one or multiple smaller channels to spread the liquid as evenly as possible over the entire cross-sectional area of the packed bed. Conversely the flow distributor on the outlet side of the column must efficiently gather liquid spread across the entire cross-sectional area and convey it out of the column through one or multiple smaller channels (e.g., a 200 mm column can have inlet/outlet ports of 6 mm diameter).

As used herein, a “bed support” is a net, screen, mesh, or frit that allows the passage of various liquids yet retains the small particles of packing medium that comprises the packed bed. These bed supports can be directly connected to the flow distributors.

As used herein, the terms “permanent bond” and “permanently bonded” are used to indicate that such a bond between two components cannot be separated other than by breaking the bond or one or both of the bonded components (e.g., a tube and a flow distributor).

As used herein, the term “induced hoop tension” refers to the circumferential stress generated in the wall of the tube by the insertion of a flow distributor with an outer diameter that is larger than the inner diameter of the tube. The diametrical difference between these values is referred herein as the interference fit. The induced hoop tension is triggered by internal stresses due to the interference fit as the flow distributor is forced to compress and deflect inward and the tube wall is stretched outward.

As used here, the term “shelf stable” as applied to a chromatography column means that such chromatography column is capable of withstanding vibration or shocks of the frequency and magnitude ordinarily found in storage settings such as warehouses, without significant degradation of structural or performance characteristics. Shelf stability also includes the retention of performance and structural characteristics during storage cycles on the order of days, weeks, or months.

As used here, the term “transport stable” as applied to a chromatography column means that such chromatography column is capable of withstanding vibration, shocks, and rotation of the frequency and magnitude ordinarily found in transportation settings (e.g., highway, rail, and/or air transport settings), without significant degradation of structural or performance characteristics.

Shelf and transport stability can be assessed according to methods currently used in the art, for example, the protocols described in International Safe Transit Association 2B Testing (ISTA2B).

The conjunctions “or” and “and/or” are used interchangeably as non-exclusive disjunctions.

The indefinite articles “a” and “an” refer to at least one of the associated noun and are used interchangeably with the terms “at least one” and “one or more.” For example, “a module” means at least one module, or one or more modules.

Overview

This disclosure provides packed chromatography columns loaded with incompressible materials such as ceramic hydroxyapatite beads, which exhibit good separation characteristics that are robust to a number of common environmental and usage factors, including transportation, storage, and multiple uses. While not wishing to be bound by any theory, it is believed that columns of the disclosure are characterized by packed beds comprising “interlocked” incompressible particles that are closely packed and resist motion relative to one another, e.g., when subjected to vibration. Additionally—and again, without wishing to be bound by any theory—in certain embodiments the packed bed is in close apposition or even contact with rigid elements such as flow regulators or rigid frits, minimizing slack space to limit sloshing of the column's contents. This may be particularly useful in withstanding the forces applied to the columns during transport and handling.

Turning first to the performance characteristics of the columns, they are generally characterized by low asymmetry (e.g. 0.9, 1, 1.1, 1.2, 1.1-1.2, etc.) and HETP (Height Equivalent to a Theoretical Plate) values that are comparable to conventionally prepared plates. Columns of this disclosure can vary in diameter from 1-200 cm in diameter, e.g., 5 cm, 10 cm, 12.6 cm, 25 cm 45 cm or 60 cm inner diameter. Bed heights in these columns can vary from 5 to 60 cm, e.g., 5, 10, 15, 20, 25, 30, 35, 40, 45, 50, 55 or 60 cm, 10-30 cm, etc.

Columns of this disclosure are prepared by pouring a resin slurry atop a rigid body such as a polymer frit and, after a stable bed has been prepared by flow settling, applying a compressive force to the bed using a second rigid body. In some cases, the second rigid body is a second polymer frit, which sits below or is integral to a flow regulator for the column. This advantageously allows compression of the bed to be done quickly during column assembly without the need to use any non-integral parts. The polymer frit may comprise a completely rigid material, or it may be somewhat compliant, to absorb some of the compressive forces applied during compression. During compression, the bed is compressed by between 2% and 20%, e.g., 2.5%, 5%, 10%, 12.5%, 15%, 17.5%, etc. Compression is applied for any suitable interval, and may be applied once or more than once. Alternatively or additionally, other packing methods may be combined with axial compression, including vibration and/or tapping, as described below. Once the bed is packed, preparation of the column may continue in the normal manner.

Columns prepared according to this disclosure are generally capable of withstanding forces that may be applied during transportation, including vibration and drops. In some cases, these forces may be simulated and the performance of the column may be tested to ensure the HETP or asymmetry values are sufficient prior to release of a column for shipment.

It should be noted that compression of CHP resins is often discouraged by manufacturers, as it is thought that the application of compressive force may contribute to fracturing of CHP particles. Additionally, some manufacturer packing protocols are referred to as “axial compression packing” but do not require the application of mechanical compressive force as the methods of this disclosure do; instead, these existing methods utilize a gas to agitate the slurry. For example, the GelTec™ chromatography column (Bio-Rad, Hercules, Calif.) may include a motor driven piston that lowers a flow adapter into the column, but the recommended packing protocols do not call for physical contact to be made between the flow adapter and the bed.

It should also be noted that the packed beds and methods of preparing them that are described above have been described with reference to pre-packed column designs. Those of skill in the art will appreciate that these packed beds and methods of preparing them can be applied to any suitable column design or usage, including without limitation poured-in-place beds and/or columns with flow regulators that are adjustable in height. Certain column configurations may not be subjected to the same stresses as the pre-packed columns described above but will nonetheless benefit from the improvements in performance and stability achieved by the embodiments of this disclosure. Without limiting the foregoing, pack-in-place column designs utilizing glass-walled vessels (e.g., Vantage® chromatography columns, EMD Millipore, Billerica, Mass., BPG™ Columns, GE Healthcare, Marlborough, Mass.), and/or columns incorporating piston-driven upper flow regulators such as the GelTec™ column described above or AxiChrom™ (GE Healthcare, Marlborough, Mass.) are used in certain embodiments of this disclosure.

Chromatography Columns

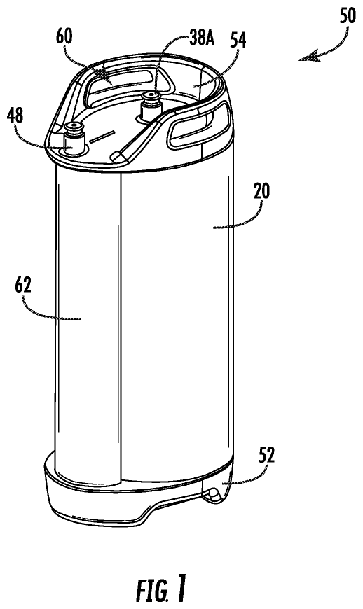

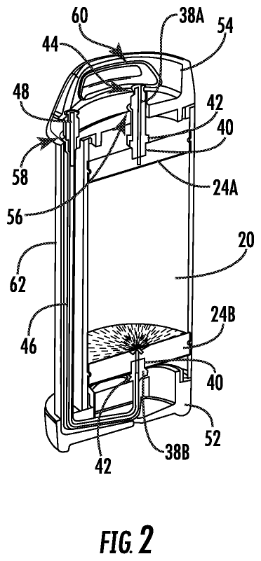

The chromatography columns 50 described herein and depicted in FIGS. 1 and 2 consist primarily of a column tube 20 and a pair of flow distributors 24A, 24B (or one flow distributor and one end cap). The flow distributors 24A, B include a cylindrical disc and one or more inlet/outlet pipes that enable liquids to flow into and through the disc. In addition, the flow distributors 24A, B can include a bed support, screen, and/or filter that are attached to the packing medium side of the flow distributor disc. The column 50 also may or may not incorporate O-rings between the flow distributors and column tube, but columns of this disclosure do not necessarily require O-rings.

The flow path of the flow distributors 24A, B can be designed according to standard practices and known designs, and the flow distributors themselves can be made, for example, of the same or a similar plastic material as the tubes, but can also be made of metal, ceramics, and other materials that are inert to the liquids and reagents that are to be flowed through the columns.

The tubes 20 are hollow, cylindrical members, which are typically round cylinders that permit a fluid (e.g., a liquid) to flow from a first end (e.g., an upper end) to a second end (e.g., a lower end). The inner diameter of the tubes are sized and configured to receive the flow distributors for delivering fluid to and removing fluid from the tube. Based on various chromatography column performance specifications, the tubes 20 can be made in a variety of different sizes and configurations. In some embodiments, the tubes 20 are sized and configured to maintain structural integrity under the induced internal operating pressures of the system while being able to withstand internal pressures up to as much as about 185 psi (e.g., about 20, 30, 40, 50, or 60 psi). In some embodiments, the tubes 20 are typically cylindrical members having an inner diameter that is about 10 cm to about 100 cm and a length that is about 10 to about 90 cm. The tubes 20 are initially selected to be about twice as long as the desired final bed height and are cut shorter once both flow distributors are secured in place within the column tube.

In general, the overall induced hoop tension of the tube 20, based on a variety of factors, can vary based on an end user's specification, such as expected internal pressure to which the chromatography column will be subjected. For example, the tube 20 must have sufficiently thick or otherwise robust walls to avoid yielding of the tube during the insertion of the flow distributors. For example, the wall thickness of the tube 20 can be large enough such that it can withstand adequate factors of safety above the maximum operating pressure via deriving desired induced hoop tension. For example, depending on the nature of the material, e.g., for polypropylene, a 20 cm column has a tube that has a nominal inner diameter of 199.90 mm and a nominal wall thickness of 10.0 mm. A 30 cm polypropylene column has a tube that has a nominal inner diameter of 300.00 mm and a nominal wall thickness of 13.0 mm. In some examples, depending on the nature of the material, a tube that has an inner diameter of 200 mm should have a wall thickness of from about 7.5 mm to 15 mm, e.g., about 8, 9, 10, 11, 12, or 13 mm. A tube having a diameter of 300 mm should have a wall thickness of about 10 to 20 mm, e.g., about 12, 13, 14, 15, 16, 17, or 18 mm. The wall thickness of the tube can be specified so that the tube has suitable strength to withstand internal pressure during use (e.g., about 20 psi to about 40 psi, e.g., 20, 25, 30, or 35 psi). Furthermore, adequate wall thickness helps to maintain the column geometry (e.g., volume) throughout the intended range of operating pressure, thereby limiting the amount of deflection of the column walls, which will help to ensure proper function of the columns. Walls may be thinner in tubes made from thermoplastics that are reinforced with additional structural materials such as glass or carbon fibers or particles.

In some examples, a tube should have an induced hoop tension of 25 PSI to 250 PSI, e.g., about 50, 75, 100, 125, 150, 175, 200, 225, or 250 PSI. The induced hoop tension of the tube can be specified so that the tube has suitable material properties to withstand internal pressure during use (e.g., about 20 psi to about 40 psi, e.g., 20, 25, 30, or 35 psi). Furthermore, adequate induced hoop tension helps to maintain the column geometry (e.g., volume) throughout the intended range of operating pressure, thereby limiting the amount of deflection of the column walls, which will help to ensure proper function of the claims. Adequate induced hoop tension also allows the column to withstand significant operational pressures and maintain a hydraulic seal without being permanently fixed in position.

In addition, the inner wall of the tube may be thinned or reduced in thickness at the ends, or at least at one end, to form a ramp or chamfer of from about 0.0 to about 20 degrees, e.g., about 1, 3, 5, 7, 9, 11, 13, 15, or 17 degrees, which can facilitate the insertion of the flow distributors. The chamfer should run from the end of the tube inwards from about 10 mm to about 30 mm. As discussed in detail below, the flow distributor has an outer diameter that is greater than the inner diameter of the tube, and the chamfers help align the flow distributor into the tube during manufacturing.

In some embodiments, a tube is a cylinder having a chamfer formed along the inner surface at each end. Flow distributors that are sized and configured to be received in the tube have an inlet hole that is hydraulically connected to an outlet hole and a network of fluid distribution conduits, such as grooves that extend from the inlet hole to the packing medium side of the flow distributor. Thus, the flow distributors are configured to receive fluid at one or more inlet locations from a first side of the flow distributor and distribute the fluid outward radially along a second side of the flow distributor that faces the packing medium when inserted into the tube. Additionally, typically by reversing the flow direction, the flow distributors can receive fluid along their entire second side and direct the fluid inward towards the one or more outlet locations on the first side.

Typically, the flow distributors 24A, B are round, disc-like members that have an outer diameter that is slightly larger than the inner diameter of the tube into which they are to be inserted, such that the insertion thereof will produce an interference fit sufficient to induce a hoop tension effective to prevent leaking up to desired internal pressures. Because the flow distributor is relatively radially incompressible and the tube wall is relatively compliant, the interference fit causes the tube to distend leading to the formation of a liquid-tight seal. For example, for a polypropylene tube 20 having an inner diameter of 200 mm, the polypropylene flow distributor can have an outer diameter of between 201 and 204 mm (e.g., about 202 mm). For an inner diameter of 300 mm, the outer diameter of the flow distributor 24 can be about 302 to 306 mm. Both the tube 20 and the flow distributors 24 A, B are designed such that the induced hoop tension during assembly is less than the yield strength of the materials. Thus, the tube walls, and in many embodiments to a lesser extent the flow distributors, experience plastic deformation and maintain their hoop tension during the life of the column. It is this hoop tension value that assures a leak-proof seal at the tube and flow distributor interface and limits the maximum operating pressure of the column.

The fittings are mechanical attachments that can be fastened or secured to the flow distributor to deliver fluid to or remove fluid from a flow distributor and the tube in which the flow distributor is arranged. To deliver fluid, the fittings have a fluid delivery hole formed through the fitting along its central axis. The fittings also include one or more features to be received in the fitting hole of the flow distributor to retain the fitting. As shown in FIGS. 1 and 2, fittings 38 have a threaded end 40 (e.g., an M30×3.5 threaded end) to engage the flow distributor 24. The fittings 38 also have a nut portion 42 that can be gripped by a tool (e.g., a torque wrench) for turning and securing the fitting 38 within the fitting hole 26. In some embodiments, the fitting 28 includes other types of connection mechanisms, such as adhesives, welding, bayonet or luer connections, or other sufficient connection techniques.

The chromatography column 50 can also further include a top end cap 54 that encloses the tube 20 and upper flow distributor 24a. The top cap 54 includes features (e.g., holes, recesses, or gripping elements) that receive and secure a portion (e.g., the upper portion) of the tube 20. The top cap 54 includes an inlet fitting hole 56 and an outlet fitting hole 58 that are sized and configured to receive the inlet fitting 38a and remote quick disconnect outlet fitting 48, respectively. The top cap 54 can also include one or more handles 60 that can be used to pick up and carry the chromatography column 50 or used to steer/direct larger columns that have integral casters or once placed on rolling carts/dollies. The top cap 54 is made from any various structurally suitable materials, such as metals, plastics, or composite materials that can support the weight of the chromatography column when it is lifted by the handle. In this example, the top cap is made from ABS, PE, PP, or glass-filled, e.g., glass-fiber, plastic.

A shroud or side-guard piece 62 can also be further included. The shroud piece 62 can be sized and configured to extend from the base 52 to the top cap 54 and cover some of the inner components of the chromatography column 50 (e.g., the hose 46 connecting the outlet fitting 38b to the remote outlet fitting 48). The shroud 62 can be formed of any various suitable materials such as metals, plastics, or composite materials.

The top and bottom flow distributors 24A, 24B are installed (e.g., press-fit) into the top and bottom of the tube 20 during the manufacturing and packing of the column. In some embodiments, the tube 20 and one or both of the flow distributors 24A, 24B are permanently bonded prior to insertion of the top flow distributor 24A and packing of the tube 20 with medium material. Following satisfactory testing of the column, the second, e.g., top, flow distributor 24A is optionally permanently bonded in place. Such permanent bonds cannot be readily separated other than by breaking the bond or the bonded items (e.g., the tube 20 and flow distributor 24A, 24B). At an upper end, an additional cap (e.g., the top cap) 54 can optionally be seated on and secured to the tube 20 and aligned so that the inlet fitting 38a installed on the flow distributor 24a at the top of the column passes through the inlet fitting hole 56 of the additional top end cap 54. Such optional top cap 54, which is primarily an aesthetic feature, can be secured to the tube 20 using various securement mechanisms, such as fasteners, adhesives, friction between the tube and the top cap, or other mechanisms.

At a lower end, the tube 20 can optionally be seated on and secured to the bottom cap (e.g., base) 52. The base 52 can be secured to the tube 20 using various securement mechanisms, such as fasteners, adhesives, friction between the tube and the bottom cap, or other mechanisms. When an optional base 52 is used, the outlet fitting 38b installed on the flow distributor 24b at the bottom of the tube 20 can extend into a cavity in the optional base 52 and the hose 46 connected to the outlet fitting 38b from the bottom flow distributor 24b is directed outward toward a region outside the periphery of the tube 20. As shown, the hose 46 can be routed out of the optional base 52 and upward along the side of the tube 20 to connect to the remote quick disconnect outlet fitting 48 that is fixed at or near the top of the column 50. By using the hose 46 and arranging the remote outlet fitting 48 near the top of the column 50, a user need not have access to the underside of the tube 20, which results in an easier to use chromatography column 50.

The chromatography column components (e.g., the tube 20, the flow distributors 24a, 24b, the fittings 38a, 38b, and other components) can be made from any of various structurally and chemically suitable plastic materials. For example, the components can be made of one or more thermoplastics (e.g., acrylonitrile butadiene styrene (ABS), acrylic (e.g., PMMA), polypropylene (PP), polyvinyl chloride (PVC), polytetrafluoroethylene (PTFE), other thermoplastics, or composites) and thermosetting plastics (e.g., epoxy resins, and fiber (e.g., glass or carbon) reinforced plastics). Material selection considerations include the specific mechanical properties of the materials and if the materials will withstand the induced internal operating pressures of the system.

### EXAMPLES

The principles of this disclosure will be further illustrated by the following non-limiting examples:

### Example 1: Control Packing

To establish a baseline for column performance using existing packing methods, a 4.4 cm inner diameter column (Vantage®, Millipore Corporation, Burlington, Mass.) was packed with a ceramic hydroxyapatite 40 μm Type 1 resin (CHT®, Bio-Rad, Hercules, Calif.) using standard vibration packing methodology. A frit was inserted into the bottom of the column (POREX®, Fairburn, Ga.), and a ceramic hydroxyapatite resin slurry was prepared and poured over the bottom frit to achieve a height of 15-20 cm. A flow distributor and second frit were inserted into the top of the column. The resin was flow-packed at 200 cm/hour to settle the bed, the flow distributor was then lowered to within lmm of the flow-settled bed and flow-packed again at 200 cm/hour for 5-minutes. The bed height was recorded at 16.4 cm prior to initiation of tap cycles.

Three tap cycles were performed as follows: Under no flow, the column was tapped at a rate of 2-3 taps per minute using a plastic rod. Three tap cycles were performed. In each cycle, tapping was performed around the circumference and along the length of the column in a semi-random pattern for 1 minute, or a K10 pneumatic ball vibrator (K-10, Vibratechniques Ltd, Sussex, UK) at 30 PSI and approximately 375 Hz. The flow was then restarted at 200 cm/hour for 1 minute.

Following the three tap cycles, bed height stabilized at 15.8 cm from. This was a 6 mm or 3.7% consolidation.

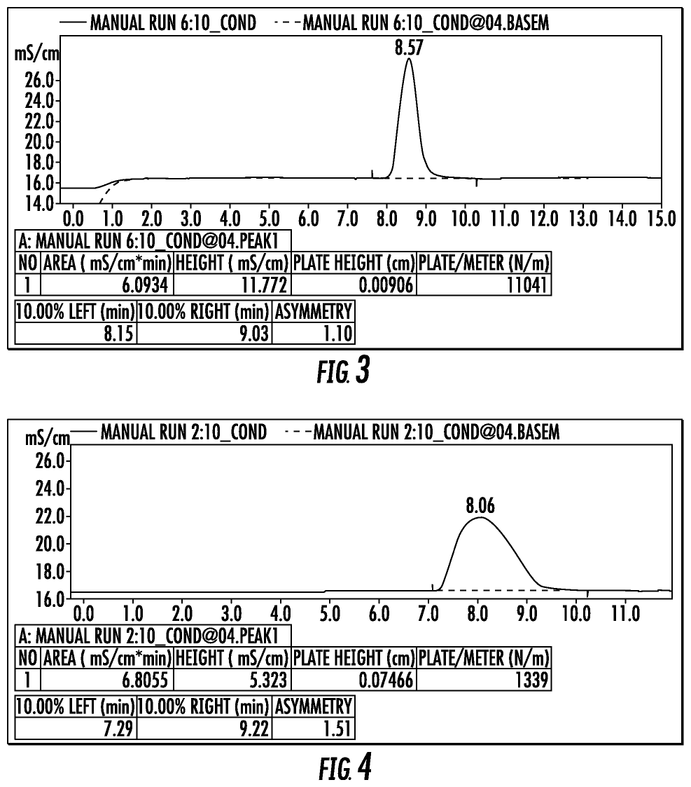

Prior to bed consolidation the performance test yielded a plate count of 11041 N/m, and a 1.1 asymmetry (FIG. 3). The manufacturer's guidance on performance for 40 um CHP is a plate count greater than 4500 N/m and asymmetry between 0.8 and 2.3. For some applications, a plate count greater than 3000 N/m is acceptable. Following consolidation with vibration the plate count dropped to 1339 with an asymmetry of 1.51 (FIG. 4). This packed bed would no longer be considered usable. Results can be found in Table 1, below:

TABLE 1
Results for Control Packing:

| | | | |
|---|---|---|---|
| | Bed height | Hetp | |
| Step | (cm) | (N/m) | Asymmetry |

| | | | | |
|---|---|---|---|---|
| 1. | initial test | 16.4 | 11041 | 1.1 |
| 2. | tap cycle 1 | 16.2 | | |
| 3. | tap cycle 2 | 15.9 | | |
| 4. | tap cycle 3 | 15.8 | 1339 | 1.51 |

These results depict the low performance achieved within this packing approach.

### Example 2: Axial Compression Packing

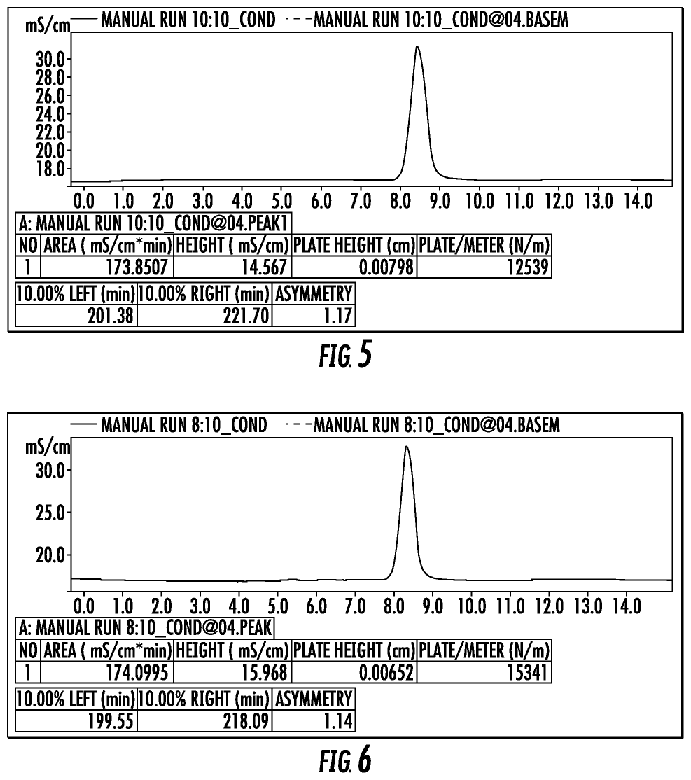

Column packing and flow-settling was performed as described in Example 1 prior to tap cycles. Chromatographic performance was tested, as shown in FIG. 5. Then, axial compression was applied by manually lowering the top frit and flow distributor and compacting the bed by 2.5% to a bed height of 16.0 cm. A test following compaction was not immediately conducted; Instead, tapping cycles were performed to evaluate stability of the bed and see if additional consolidation occurs. No reduction in bed height was seen, indicating the bed did not consolidate further.

Results of axial compression packing are shown in Table 2, below:

TABLE 2
Results for Axial Compression Packing:

| | | Bed height | Hetp | |
|---|---|---|---|---|
| Step | | (cm) | (N/m) | Asymmetry |
| 1. | Re-pack and test | 16.4 | 12539 | 1.17 |
| 2. | Compaction of resin bed | 16.0 | | |
| 3. | 3 tap cycles | 16.0 | 15341 | 1.14 |
| 4. | Vibration - 3 cycles | 16.0 | 12166 | 1.15 |
| 5. | 3 Vibration and 3 tapping | 16.0 | 12660 | 1.15 |
| 6. | Dried out column with 60 ml air | 16.0 | 12364 | 1.15 |
| | then tested w/no EQ | | | |
| 7. | Compacted additional 2 mm | 15.8 | 11996 | 1.15 |
| 8. | Flow at 100 cm/hr horizontally | 15.8 | 11010 | 1.69 |
| | for 1 hr, Test while horizontal | | | |
| 9. | Flow in vertical position 100 | 15.8 | 9212 | 1.24 |
| | cm/hr down flow 1 cv | | | |
| 10. | 2 cv additional down flow | 15.8 | 13288 | 1.25 |

The chromatographic performance of axially compressed columns was slightly better (15341 N/m compared to 12539 N/m) than the initial result (Table 2, #3) (FIG. 6). To further stress test the compression packed bed, the column was vibrated with K10 vibrator for three complete cycles and tested. The vibration cycles did not significantly impact the packed bed. No decrease in bed height was observed and plate count was stable above 12,000 N/m. Asymmetry was also unchanged (Table 2, #4). The packed column was subjected to 3 additional rounds of vibration and tapping then tested. No impact to the performance results or further bed consolidation was observed (Table 2, #5).

### Example 3: Stress Testing of Axially Compressed Packed Beds

Three additional stress tests were performed on the compression packed column prepared in Example 2. First, the column was dried by air injection. 60 ml of air (25% of bed volume) was injected into the top of the column. The column was immediately tested without a rehydration period, though it is noted that columns with larger interior diameters may benefit from a rehydration period. Visually the column was dry with air exiting the outlet line but quickly rehydrated within the first minute of down flow during the pulse injection test. There was no significant change in plates or asymmetry (Table 2, #6) (FIG. 7).

Second, additional compression was applied by lowering the flow adapter by an additional 2 mm. The column was re-tested and no significant change in performance was detected. (Table 2, #7).

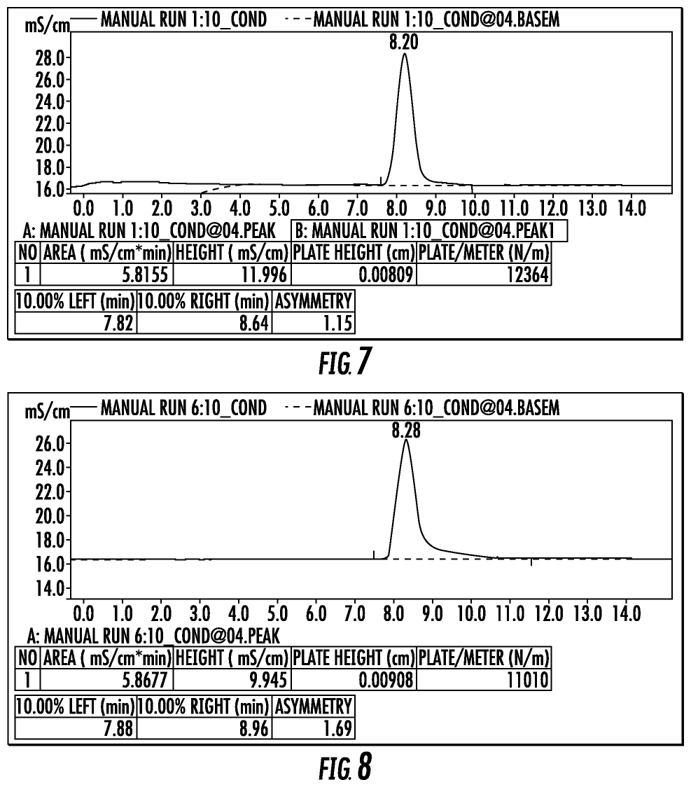

Finally, the column was operated horizontally to assess the quality of packing of the column—a loosely packed column would be expected to re-settle and form flow-channels, degrading performance. The column was operated in the horizontal position at 100 cm/hr flow for 1 hour then tested under the same condition. The loss in plate count was less than 10% but a significant change in asymmetry was observed, 1.15 to 1.69 (Table 2, #8), and a slight tailing to the peak was visible in the chromatogram (FIG. 8). This change although significant did not bring the performance result out of specification. Visually there was no channel or gap observed within the bed.

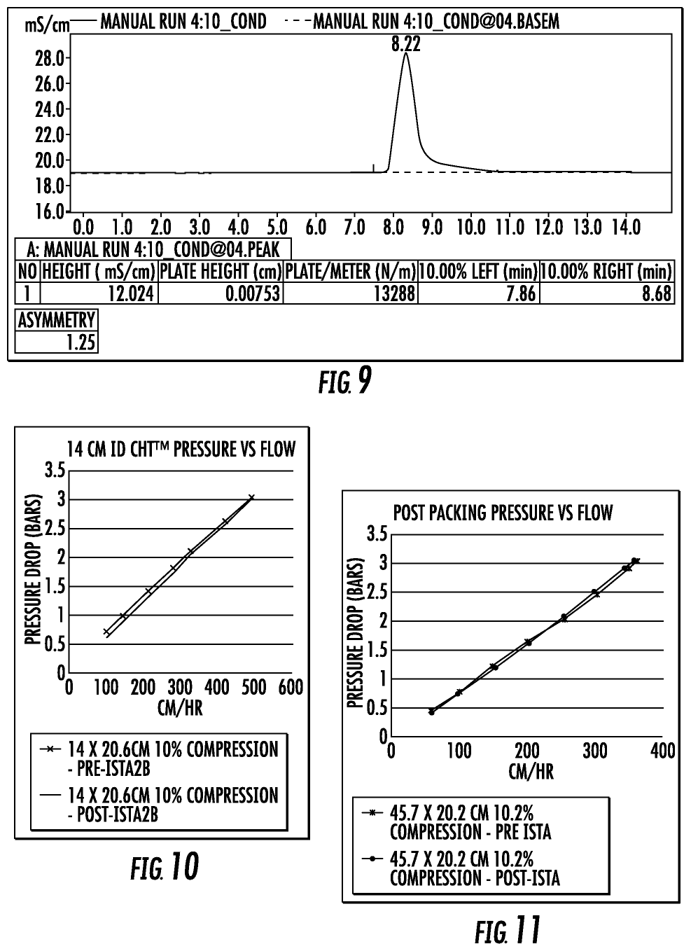

The column was re-positioned vertically and flow conditioned at 100 cm/hr for 1 column volume (CV) and then tested (Table 2, #9) (FIG. 9). Asymmetry improved to 1.24 and but plate count dropped to 9212 N/m, still a very high efficiency result. An additional 2CVs of flow conditioning was performed followed by testing. Asymmetry did not change but plate count improved to 13288 N/m demonstrating that a bed could be reconditioned to near original performance (Table 2, #10). Results indicate the compressed bed is very robust and can even handle operation with a non-level bed contradictory to the manufactures guidance.

Based on these results, bed compaction of 2.5% using axial compression at this column scale was sufficient to stabilize the bed height from further consolidation and prevent loss of performance due to the vibrational shear. This result is contradictory to what would be expected based on the recommendation from the CHT™ manufacturer. While not wishing to be bound by any theory, it is hypothesized that bed compaction locks the particles in place preventing further consolidation and destabilizing of the bed. The “locked” particles may also resist vibrational shear forces if movement is restricted.

### Example 4: Testing Different Levels of Packed Bed Compression

To determine the effect of chromatographic efficiency and asymmetry as a result of compression, a 12.6 cm internal diameter OPUS® (Repligen Corporation, Waltham, Mass.) column was packed with ceramic hydroxyapatite 40 μm Type 1 resin (CHT™, Bio-Rad, Hercules, Calif.). A polyethylene frit was inserted into the bottom of the column (POREX®, Fairburn, Ga.). A ceramic hydroxyapatite resin slurry was prepared in phosphate buffered saline (PBS) and poured into the column to a bed height of 18-25 cm. A flow distributor and second frit were inserted into the top of the column. The resin was flow packed at a fluid velocity of 100 cm/hour with PBS to settle the bed. The settled bed height under 100 cm/hr flow was 23.0 cm. While maintaining a 100 cm/hr fluid velocity, the flow distributor was lowered at 100 cm/hr Dynamic Axial Compression (DAC) to within lmm of the flow settled bed. The column was conditioned for 3 column volumes at a flow rate that provided a 3 bar pressure drop, which resulted the bed to consolidate under flow to a bed height of 22.5 cm. The initial test was performed at 22.5 cm, a 2.2% consolidation from the original flow settled bed height.

Prior to compressing the flow distributor into the settled resin bed, the column was tested for HETP (N/m) and asymmetry. The initial test result with no bed compression was 6985 N/m and 1.85 asymmetry. The flow distributor was then lowered into the resin bed at 0.5 cm intervals and performance tested at each point. The percent compression was calculated from the original flow settled bed height (23 cm) observed under 100 cm/hr prior to lowering the top flow distributor. Column efficiency and asymmetry improved as compression increased up to 8.7% and then decreased slowly with additional compression. At 19.6% compression the column efficiency was 6366 N/m and asymmetry was 1.42. This result still meets the manufacturers recommended performance specification. All performance results are in Table 3.

TABLE 3
Results of 12.6 cm internal diameter compression
packing can be found in the Table below:

| | Bed Height | HETP | |
|---|---|---|---|
| Step | (cm) | (N/m) | Asymmetry |
| Initial Test | 22.5 | 6985 | 1.85 |
| 4.3% Compression | 22.0 | 8970 | 1.44 |
| 6.5% Compression | 21.5 | 8721 | 1.4 |
| 8.7% Compression | 21.0 | 9051 | 1.33 |
| 10.9% Compression | 20.5 | 8572 | 1.33 |
| 13% Compression | 20.0 | 8225 | 1.33 |
| 15.2% Compression | 19.5 | 7698 | 1.36 |
| 17.4% Compression | 19.0 | 7243 | 1.43 |
| 19.6% Compression | 18.5 | 6366 | 1.42 |

### Example 5: 14 cm Compression Packing with ISTA Ship Testing

Column packing, flow-settling, flow-conditioning were performed as described in Example 4. There was no Polyethylene frit used in this experiment. A 14 cm internal diameter with OPUS® (Repligen Corporation, Waltham, Mass.) column was packed with ceramic hydroxyapatite 40 μm Type 1 resin (CHT™, Bio-Rad, Hercules, Calif.). The column was packed to a final compression of 10%. The percent compression was calculated from the 100 cm/hr flow settled bed height prior to lowering the top flow distributor. The resulting bed height under 10% compression was 20.6 cm.

At 10% compression the column was stored in 0.1 N Sodium Hydroxide with 10 mM Sodium Phosphate and packaged to be tested for International Safe Transit Association 2B Testing (ISTA2B) at UN1F1ED2 Global Packing Group, Sutton, Mass. The ISTA2B procedure included Test Categories of: Compression of 710 lbs for 1 hour, Random Vibration at Gᵣₘₛ Level of 1.15, Shock: Incline Impact of at least 1.7 m per second, Shock: Rotational Edge Drop at 8 inches, and a second round of Random Vibration at Gᵣₘₛ Level of 1.15. The column was tested for column efficiency and asymmetry pre and post ISTA2B testing. Packed bed performance attributes did not change significantly following the shipping simulation (Table 4).

The pressure vs flow profile pre and post ISTA2B remained unchanged (FIG. 10). These data along with the maintained chromatographic performance indicates that a 14 cm internal diameter column packed at a compression of 10% is sufficiently stable for shipping.

TABLE 4
Results of 14 cm internal diameter compression
packing with ISTA Ship Testing

| | Bed Height | HETP | |
|---|---|---|---|
| Step | (cm) | (N/m) | Asymmetry |
| 10.0% Compression | 20.6 | 8264 | 1.17 |
| Pre-ISTA2B | | | |
| 10.0% Compression | 20.6 | 8392 | 1.22 |
| Post-ISTA2B | | | |

### Example 6: Scale-Up Compression Packing with ISTA Ship Testing, 45.7 cm LD. Column

To demonstrate the scalability of the compression packing method, a 45.7 cm internal diameter OPUS® (Repligen Corporation, Waltham, Mass.) column was packed with ceramic hydroxyapatite 40 μm Type 1 resin (CHT™, Bio-Rad, Hercules, Calif.). Column packing, flow-settling, flow-conditioning were performed as described in Example 4 and 5. There was no Polyethylene frit used in this experiment. The column was packed to a final compression of 10.2%. The percent compression was calculated from the 100 cm/hr flow settled bed height prior to lowering the top flow distributor. The resulting bed height under 10.2% compression was 20.2 cm.

At 10.2% compression the column was stored in 0.1 N Sodium Hydroxide with 10 mM Sodium Phosphate and packaged to be tested for International Safe Transit Association 2B Testing (ISTA2B) at UN1F1ED2 Global Packing Group, Sutton, Mass. The ISTA2B procedure included Test Categories of: Atmospheric Preconditioning, Atmospheric Conditioning, Random Vibration at Gᵣₘₛ Level of 1.15, Shock: Incline Impact of at least 1.7 m per second, Shock: Rotational Edge Drop at 8 inches, and a second round of Random Vibration at Gᵣₘₛ Level of 1.15. The column was tested for column efficiency and asymmetry pre and post ISTA2B testing. Packed bed performance attributes did not change significantly following the shipping simulation (Table 5).

The pressure vs flow profile pre and post ISTA2B remained unchanged (FIG. 11). These data along with the maintained chromatographic performance indicates that a 45.7 cm internal diameter column packed at a compression of 10% is sufficiently stable for shipping.

TABLE 5
Results of 45.7 cm internal diameter compression
packing with ISTA Ship Testing

| | Bed Height | HETP | |
|---|---|---|---|
| Step | (cm) | (N/m) | Asymmetry |
| 10.2% Compression | 20.2 | 9182 | 1.02 |
| Pre-ISTA2B | | | |
| 10.2% Compression | 20.2 | 9118 | 1.09 |
| Post-ISTA2B | | | |

### Example 7: Compression Packing Method on CHTIM (80 μm)

80 μm ceramic hydroxyapatite Type 1 resin (CHT™, Bio-Rad, Hercules, Calif.) was packed into a 10 cm internal diameter OPUS Column (Repligen Corporation, Waltham, Mass.). Column packing, flow-settling, flow-conditioning were performed as described in Example 4, 5 and 6. The column was tested for column efficiency and asymmetry before mechanical compression and at several compression intervals (5.8%, 7.9%, 10.2% and 12.4% compression). The percent compression was calculated from the flow settled bed height observed under 100 cm/hr prior to lowering the top flow distributor. A bed height of 22.6 cm was observed. Following the final compression at 12.4%, the column performance and packed bed stability were stress tested. The packed column was placed on a Vibco® Vibration Table (Vibco INC., Wyoming, R.I.) with Table US-RD-18×18 and Vibrator SC-500T. 5 cycles of 1 minute vibration followed by 1 min flow at 3 bar pressure were performed. The column was further stress tested by performing 4 cycles of gravity drops (each cycle consists of 10 drops from 2-3 inches high) followed by 1 min flow.

TABLE 6
Results of 10 cm internal diameter compression
packing CHT ™ Type 1 80 μm

| | Bed Height | HETP | |
|---|---|---|---|
| Step | (cm) | (N/m) | Asymmetry |
| Initial Test | 21.8 | 3892 | 1.73 |
| 5.8% Compression | 21.3 | 2861 | 1.55 |
| 7.9% Compression | 20.8 | 3030 | 1.41 |
| 10.2% Compression | 20.3 | 2867 | 1.44 |
| 12.4% Compression | 19.8 | 2717 | 1.42 |
| 12.4% Compression | 19.8 | 2699 | 1.44 |
| After 5 Vibration | | | |
| Cycles | | | |
| 12.4% Compression | 19.8 | 2614 | 1.45 |
| After 4 Drop Cycles | | | |

Following compression to 7.9% no change in asymmetry was observed, however there was a decrease in column efficiency from 7.9% (3030 N/m) to 12.4% (2717 N/m). These performance results are still within the manufacturers recommended specs.

There was no change in column efficiency and asymmetry after the column was stress tested via vibration and drop cycles. These results demonstrate that the compression packing method is suitable to pack CHT™ Type 1, 80 μm resulting in good column performance and stable packed bed.

1. A chromatography column, comprising:
a tubular member having first and second ends;
a first flow distributor secured to a first end of the tubular member;
a second flow distributor secured to a second end of the tubular member; and
a packed chromatography medium comprising an incompressible component, the packed chromatography medium being disposed in the tubular member between the first and second flow distributors,
wherein the packed chromatography medium is formed by compression between the first and second flow distributors, and
wherein a separation performance of the column is characterized by a height-equivalent theoretical plate (HETP) value and an asymmetry value, and wherein (a) the HETP value does not change by more than 10% and/or (b) the asymmetry value does not change by more than 10% following a vibration exposure selected from (I) fixed displacement vibration of 25 mm total fixed displacement or (II) random displacement vibration of an overall Gᵣₘₛ level of 1.15.

2. The column of claim 1, wherein (a) the HETP value does not change by more than 10% and/or (b) the asymmetry value does not change by more than 10% following a shock exposure selected from (I) a drop of 150 mm, (II) an incline impact causing at least a 1.7 m/s velocity change, or (III) a horizontal impact causing at least a 1.7 m/s velocity change.

3. The column of claim 1, wherein (a) the HETP value does not change by more than 10% and/or (b) the asymmetry value does not change by more than 10% following a sequence of vibration-shock-vibration exposures, wherein the shock exposure is selected from (I) a drop of 150 mm, (II) an incline impact causing at least a 1.7 m/s velocity change, or (III) a horizontal impact causing at least a 1.7 m/s velocity change and wherein the vibration exposure is selected from (IV) fixed displacement vibration of 25 mm total fixed displacement or (V) random displacement vibration of an overall Gᵣₘₛ level of 1.15.

4. The column of claim 1, wherein the HETP and asymmetry values do not change by more than 5%.

5. The column of claim 1, wherein the incompressible component comprises a 40 μm ceramic hydroxyapatite.

6. A shelf and transportation stable chromatography column, comprising:
a tubular member having first and second ends;
a first flow distributor secured to a first end of the tubular member;
a second flow distributor secured to a second end of the tubular member; and
a packed chromatography medium comprising an incompressible component, the packed chromatography medium being disposed in the tubular member between the first and second flow distributors.

7. The chromatography column of claim 6, wherein the packed chromatography medium is compressed by at least 2%.

8. The chromatography column of claim 7, wherein the packed chromatography medium is compressed by no more than 20%.

9. The chromatography column of claim 6, wherein the incompressible component comprises silica, controlled pour glass, ceramics, or apatites.

10. The chromatography column of claim 6, wherein the incompressible component is irregular or spherical.

11. The chromatography column of claim 6, wherein at least one of the first and second flow distributors comprises a porous polyethylene, polypropylene or polytetrafluoroethylene frit.

12. The chromatography column of claim 6, wherein the tubular member is oriented vertically during operation, and wherein a height of the packed chromatography medium within the tubular member remains substantially constant over at least 2, 3, 4, 5, 6, 7, 8, 9 or 10 chromatographic use cycles.

13. The chromatography column of claim 6, wherein a separation performance of the column is characterized by a height-equivalent theoretical plate (HETP) value and an asymmetry value, and wherein (a) the HETP value does not decrease by more than 2%, 3%, 4%, 5%, 10%, 20%, 30%, 40% or 50% over at least 2, 3, 4, 5, 6, 7, 8, 9 or 10 chromatographic use cycles, and/or (b) the asymmetry value does not increase or decrease by more than 5%, 10%, 20%, 30%, 40% or 50% over at least 2, 3, 4, 5, 6, 7, 8, 9 or 10 chromatographic use cycles.

14. The column of claim 13, wherein the HETP value and/or asymmetry value does not change by more than 10% following a vibration exposure selected from (I) fixed displacement vibration of 25 mm total fixed displacement or (II) random displacement vibration of an overall Gᵣₘₛ level of 1.15.

15. The column of claim 13, wherein (a) the HETP value does not change by more than 10% and/or (b) the asymmetry value does not change by more than 10% following a shock exposure selected from (I) a drop of 150 mm, (II) an incline impact causing at least a 1.7 m/s velocity change, or (III) a horizontal impact causing at least a 1.7 m/s velocity change.

16. The column of claim 13, wherein (a) the HETP value does not change by more than 10% and/or (b) the asymmetry value does not change by more than 10% following a sequence of vibration-shock-vibration exposures, wherein the shock exposure is selected from (I) a drop of 150 mm, (II) an incline impact causing at least a 1.7 m/s velocity change, or (III) a horizontal impact causing at least a 1.7 m/s velocity change and wherein the vibration exposure is selected from (IV) fixed displacement vibration of 25 mm total fixed displacement or (V) random displacement vibration of an overall Gᵣₘₛ level of 1.15.

17. The chromatography column of claim 6, wherein the tubular member is oriented vertically during operation, and wherein a height of the packed chromatography medium within the tubular member remains substantially constant before and after shipping or storage.

18. The chromatography column of claim 6, wherein a separation performance of the column is characterized by a height-equivalent theoretical plate (HETP) value or an asymmetry value, and wherein the HETP value and/or the asymmetry value remains substantially constant before and after shipping or storage.

19. The chromatography column of claim 6, wherein a height of the packed chromatography medium within the tubular member remains substantially constant before and after shipping or storage.

20. A method of making a chromatography column, comprising:
compressing, between a first and a second flow distributor, a settled incompressible chromatography medium by at least 2.5%, thereby making a packed chromatography medium.

21. The method of claim 20, wherein the packed chromatography medium is compressed by no more than 20%.

22. The method of claim 20, wherein at least one of the first and second flow distributors comprises a porous polyethylene, polypropylene or polytetrafluoroethylene frit.

23. The method of claim 20, wherein the incompressible chromatography medium is a ceramic hydroxyapatite resin.

24. The method of claim 20, wherein the incompressible chromatography medium is poured into the column to a bed height of 18-35 cm.

25. The method of claim 20, wherein a first frit is inserted into the bottom of the column, a ceramic hydroxyapatite resin slurry is poured over the first frit to achieve a height of 5-30 cm, and a flow distributor and second frit are inserted into the column.

26. The method of claim 25, wherein the resin is flow-packed at 200 cm/hour, the flow distributor is lowered to within 1 mm of the resin, and flow-packed at 200 cm/hour.

27. The chromatography column of claim 6, wherein the packed chromatography medium is formed by compression between the first and second flow distributors.
